(19) United States
(12) Patent Application Publication
(10) Pub. No.: US 2025/0230845 A1
(43) Pub. Date: Jul. 17, 2025

(54) ACTUATION ASSEMBLY AND METHOD FOR HYDRAULICALLY ACTUATING AT LEAST TWO SUB-CLUTCHES/BRAKES

(71) Applicant: Schaeffler Technologies AG & Co. KG, Herzogenaurach (DE)

(72) Inventors: David Huber, Oppenau (DE); Marco Grethel, Bühlertal (DE)

(73) Assignee: Schaeffler Technologies AG & Co. KG, Herzogenaurach (DE)

(21) Appl. No.: 18/704,523

(22) PCT Filed: Oct. 17, 2022
(86) PCT No.: PCT/DE2022/100761

§ 371 Date: Apr. 25, 2024

(30) Foreign Application Priority Data
Nov. 17, 2021 (DE) 10 2021 129 978.0

(51) Int. Cl. F16D 25/10; F16D 13/52; F16D 25/08; F16D 55/40; F16D 65/18; F16D 121/04; F16D 125/06

(52) U.S. Cl. CPC F16D 25/10; F16D 25/083; F16D 55/40; F16D 65/186; F16D 13/52; F16D 2121/04; F16D 2125/06; F16D 2300/08

(57) ABSTRACT

An actuation assembly for hydraulically actuating first and second sub-clutches or brakes includes a hydraulic functional release surface, a first pressing surface, a second pressing surface, and a common release connection. The first pressing surface is larger than the hydraulic functional release surface and arranged to generate a pressing force to the first sub-clutch or brake to transmit torque. The second pressing surface is larger than the hydraulic functional release surface and arranged to generate a pressing force to the second sub-clutch or brake to transmit torque. The common release connection is for bridging respective release paths of the first and second sub-clutches or brakes before the first and second sub-clutches or brakes transmit respective torques.

### CROSS-REFERENCE TO RELATED APPLICATIONS

This application is the United States National Phase of PCT Appln. No. PCT/DE2022/100761 filed Oct. 17, 2022, which claims priority to German Application No. DE102021129978.0 filed Nov. 17, 2021, the entire disclosures of which are incorporated by reference herein.

### TECHNICAL FIELD

The present disclosure relates to an actuation assembly and a method for hydraulically actuating at least two sub-clutches/brakes.

### BACKGROUND

From the international, unexamined application WO 2019/219971 A1 a dual clutch unit for variable torque distribution to two output shafts is known. The dual clutch unit includes an outer disc carrier that can be driven to rotate about an axis of rotation, a first inner disc carrier, a first disc pack to transmit torque between the outer disc carrier and the first inner disc carrier, and a second inner disc carrier. The first inner disc carrier and the second inner disc carrier are arranged rotatably relative to one another about the axis of rotation. The dual clutch unit also includes a second disc pack to transmit torque between the outer disc carrier and the second inner disc carrier.

### SUMMARY

The present disclosure provides an actuation assembly for hydraulically actuating at least two sub-clutches/brakes, during the actuation of which, an release path is bridged before the respective sub-clutch/brake transmits a torque. For quickly bridging the release path, the actuation assembly has at least one hydraulic functional release surface and at least one functional pressing surface, which is larger than the functional release surface in order to generate a pressing force required to transmit torque. The actuation assembly also has a common release connection for bridging the release paths of the sub-clutches/brakes.

The common release connection is a hydraulic connection, possibly also via a hydraulic line or a hydraulic channel, via which the hydraulic functional release surface can be acted upon with hydraulic medium. The hydraulic functional release surface is provided, for example, on a piston that can be moved back and forth in a hydraulic cylinder. Two hydraulic release surfaces, which are provided on two pistons, can also be supplied with hydraulic medium via the common release connection. The piston(s) can also be referred to as release pistons.

The sub-clutches/brakes may be wet-running clutches or brakes, e.g., multi-disc clutches or multi-disc brakes. In these wet-running applications, the release path may be so large that unwanted friction torques that occur during operation are reduced. If torque transmission is requested, the release paths or release path regions must be traversed quickly and precisely. For special applications, e.g., in the case of torque vectoring, two clutches must also decouple a drive in addition to performing a torque distribution function. The release path region is therefore large and must be bridged quickly.

The functional release surface, or the two functional release surfaces, may be smaller than the functional pressing surfaces. With the relatively small functional release surface, the release path can be quickly bridged. The larger functional pressing surface is suitable for building up the pressing force. The number of necessary connections can be reduced from four to three thanks to the common release connection, via which a common functional release surface or two separate functional release surfaces are supplied with hydraulic medium.

In an exemplary embodiment of the actuation assembly, the sub-clutches/brakes are each assigned a pressing connection, via which the sub-clutches/brakes can be subjected to different pressing forces. The actuation assembly includes exactly two sub-clutches/brakes in order to enable a desired torque distribution to both sides of the drive during torque vectoring in a drive train. The functional pressing surfaces can be supplied with hydraulic medium independently of one another via the separate pressing connections in order to ensure the desired torque distribution in the drive train.

In a further embodiment of the actuation assembly, the actuation assembly includes at least two annular pistons, each of which has an annular surface which is hydraulically connected to only the common release connection. The two annular surfaces of the annular pistons can be supplied with hydraulic medium via the common release connection in order to quickly bridge the release paths on both sub-clutches/brakes. However, the two annular pistons can also be subjected to a desired contact pressure independently of one another via the separate pressing connections.

In a further embodiment of the actuation assembly, the annular pistons each have a stepped side on which the respective annular surface is formed. The annular pistons delimit a common annular release space in an axial direction with the annular surfaces on their stepped sides. The common release connection is connected to the common annular release space, for example via a radial channel in a housing body. The annular pistons with their stepped sides can be manufactured and assembled cost-effectively with the desired functionality.

In a further embodiment of the actuation assembly, the annular pistons with their annular surfaces are arranged in a radially nested manner. In this way, axial installation space can be effectively saved.

In a further embodiment of the actuation assembly, the annular pistons can be moved relative to one another in the axial direction with the interposition of a sealing device. In this way, radial installation space can also be saved.

In a further embodiment of the actuation assembly, the pressing connections and the common release connection are provided on a housing body in which the annular pistons are also accommodated so as to be movable back and forth. By sharing the common release connection with the two pistons, a seal and a hydraulic inlet can be dispensed with. The pressing forces exerted hydraulically via the various connections can be varied independently of one another using suitable diameters at the sealing points.

In a further exemplary embodiment of the actuation assembly, two annular pressing spaces and a common annular release space are formed in the housing body, and the annular spaces are hydraulically separated from one another by sealing devices and/or the annular pistons.

In a further exemplary embodiment of the actuation assembly, the annular pistons are connected to disc packs via bearing devices and pressure pieces for force transmission. On the one hand, the two annular pistons can be subjected to hydraulic pressure together via the common release connection. In addition, the two annular pistons can be supplied with hydraulic pressure independently of one another via the separate pressing connections. The hydraulically generated pressing forces are transferred to the disc packs of the disc clutches or disc brakes via the bearing devices and the pressure pieces.

In a further embodiment of the actuation assembly, the hydraulic functional release surface is provided on at least one piston which can be moved back and forth in a hydraulic cylinder. The hydraulic functional release surface is provided, for example, on just one piston, which is coupled to several press pistons. The functional release surface can also be provided on a plurality of pistons, each of which is coupled to a press piston. The release path can be quickly bridged via the common release connection and a mechanical coupling, for example, to the one or more press pistons. Via the independently provided functional pressing surfaces on the press pistons, they can be supplied with hydraulic medium independently of one another via their separate pressing connections in order, for example, to realize torque distribution or torque vectoring in a drive train.

In a method for hydraulically actuating at least two sub-clutches/brakes with a previously described actuation assembly, the release paths of the sub-clutches/brakes are bridged via the common release connection before the pressing forces required to generate a desired torque transmission are generated independently of one another via the functional pressing surfaces of the sub-clutches/brakes.

### BRIEF DESCRIPTION OF THE DRAWINGS

Further advantages, features and details of the present disclosure are apparent from the following description, in which various exemplary embodiments are described in detail with reference to the drawing. In the drawing:

FIG. 1 shows a dual clutch with two radially nested sub-clutches, which can be actuated via an actuation assembly with a common release connection, in half section;

FIG. 2 shows an enlarged section from FIG. 1; and

FIG. 3 shows an enlarged section from FIG. 2.

### DETAILED DESCRIPTION

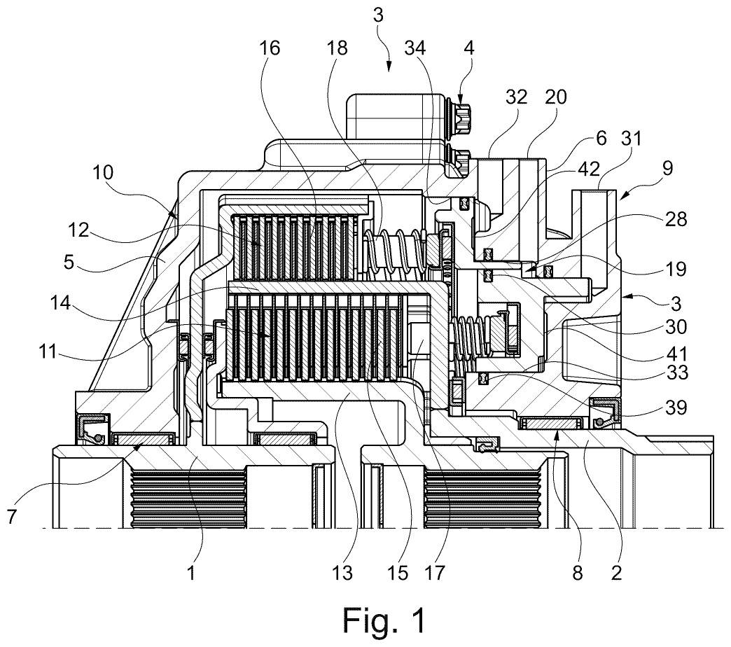

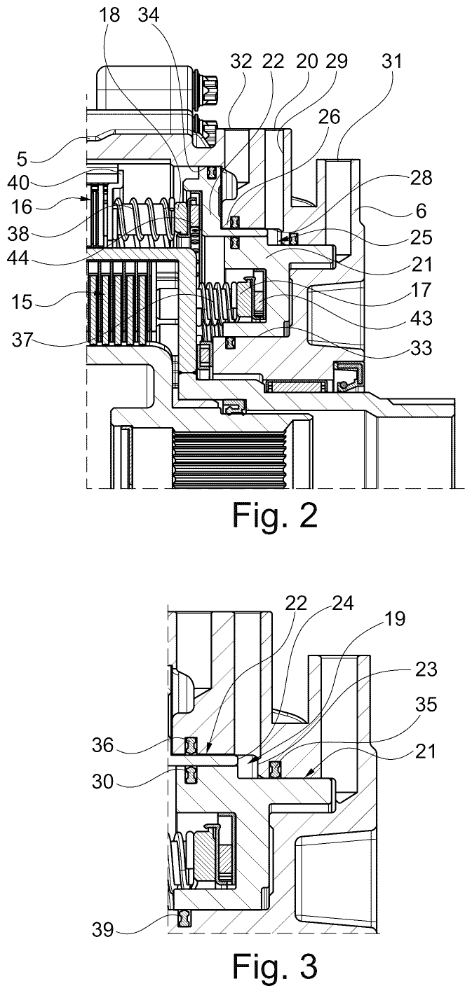

In FIGS. 1 to 3, a dual clutch 10 with two clutches 11, 12 designed as multi-disc clutches is shown in half section and in enlarged sections. The two clutches 11, 12 are also referred to as the first clutch 11 and the second clutch 12.

The two clutches 11 and 12 may also be referred to even more generally as sub-clutches/brakes 11, 12. The background to this is that an actuation assembly 9 can be used both for actuating clutches, e.g., multi-disc clutches, and for actuating brakes, e.g., multi-disc brakes.

The dual clutch 10 is arranged in a housing 3, which includes two housing bodies 5, 6, which are fastened to one another using screws 4. Two shafts 1, 2 are rotatably mounted in the housing 3 with the aid of bearing devices 7, 8. The shafts 1, 2 are also referred to as the first shaft 1 and the second shaft 2.

The first clutch 11 includes a first disc pack 15, while the second clutch 12 includes a second disc pack 16. The two disc packs 15, 16 include friction discs and steel discs, which are brought into frictional contact to transmit torque with the help of pressure pieces 17, 18. The discs of the disc packs 15, 16 are arranged alternately and are suspended in the disc carriers radially on the inside and radially on the outside in a known manner.

A first disc carrier 13 is connected to the first shaft 1 in a rotationally fixed manner. A second disc carrier 14 is connected to the second shaft 2 in a rotationally fixed manner. A first spring 37 is assigned to the first disc pack 15. A second spring 38 with a spring retaining ring 40 is assigned to the second disc pack 16.

The first pressure piece 17 can be actuated by a first piston 21 with the interposition of a bearing device 43 designed as an axial bearing. The second pressure piece 18 can be actuated by a second piston 22 with the interposition of a bearing device 44 designed as an axial bearing.

When actuated by the first piston 21 or by the second piston 22, a release clearance between the discs of the disc packs 15, 16 must first be overcome in a known manner before the discs are pressed together with a large pressing force to transmit torque. The release clearance that needs to be overcome is also referred to as the release path.

According to an example aspect, the actuation assembly 9 includes a common release connection 20, via which a common hydraulic functional release surface 19 can be specifically acted upon with hydraulic pressure in order to overcome the release clearance of the two clutches 11, 12. As soon as the release clearance or the release path of the clutches 11, 12 has been overcome, the two clutches 11, 12 can be subjected to different contact pressures via separate pressing connections 31, 32.

The first piston 21 has a first annular surface 23 on a stepped side 25. The second piston 22 has a second annular surface 24 on a stepped side 26. The two annular surfaces 23, 24 together both represent the common hydraulic functional release surface 19, which can be acted upon by hydraulic pressure via the common release connection 20.

The pressurization of the common hydraulic release surface 19 takes place via a common annular release space 28. The common annular release space 28 is connected to the common release connection 20 on the housing body 6 via a radial connecting channel 29.

The two pistons 21, 22 can be moved relative to one another in the axial direction with the interposition of a sealing device 30. The two pistons 21, 22 are arranged nested in the radial direction. The first pressing connection 31 is connected to a first annular pressing space 33, which is arranged radially within a second annular pressing space 34, which in turn is connected to the second pressing connection 32.

Functional pressing surfaces 41, 42 provided on the two pistons 21, 22, which can be subjected to a contact pressure via the pressing connections 31, 32, are larger than the hydraulic functional release surface 19. This provides, among other things, that the release clearance can be overcome quickly and the two clutches 11, 12 can be subjected to different contact pressures independently of one another via the separate pressing connections 31, 32.

The pressing connections 31, 32 and the common release connection 20 are provided on the housing body 6, which also includes the annular spaces 33, 34 and 28. A plurality of stationary sealing devices 35, 36 and 39 are provided for sealing purposes. The sealing devices include both stationary and moving seals. If all connections, i.e., the two pressing connections and the common release connection, are depressurized, a decoupling functionality can be implemented.

### REFERENCE NUMERALS

1 First shaft
2 Second shaft
3 Housing
4 Screws
5 Housing body
6 Housing body
7 Bearing device
8 Bearing device
9 Actuation assembly
10 Dual clutch
11 First clutch
12 Second clutch
13 First disc carrier
14 Second disc carrier
15 First disc pack
16 Second disc pack
17 First pressure piece
18 Second pressure piece
19 Hydraulic functional release surface
20 Common release connection
21 First piston
22 Second piston
23 First annular surface
24 Second annular surface
25 Stepped side
26 Stepped side
28 Common annular release space
29 Connecting channel
30 Sealing device
31 First pressing connection
32 Second pressing connection
33 First annular pressing space
34 Second annular pressing space
35 Sealing device
36 Sealing device
37 First spring
38 Second spring
39 Sealing device
40 Spring retaining ring
41 Functional pressing surface
42 Functional pressing surface
43 Bearing device
44 Bearing device

1. An actuation assembly for hydraulically actuating at least two sub-clutches/brakes, during the actuation of which a release path is bridged before the respective sub-clutch/brake transmits a torque, wherein, for quickly bridging the release path, the actuation assembly has at least one hydraulic functional release surface and at least one functional pressing surface, which is larger than the at least one functional release surface in order to generate a pressing force required to transmit torque, wherein the actuation assembly has a common release connection for bridging the release paths of the sub-clutches/brakes.

2. The actuation assembly according to claim 1, wherein the sub-clutches/brakes are each assigned a pressing connection, via which the sub-clutches/brakes can be subjected to different pressing forces.

3. The actuation assembly according to claim 2, wherein the actuation assembly comprises at least two annular pistons, each of which has an annular surface which is hydraulically connected to only the common release connection.

4. The actuation assembly according to claim 3, wherein the annular pistons each have a stepped side on which the respective annular surfaces are formed.

5. The actuation assembly according to claim 3, wherein the respective annular surfaces are arranged radially nested.

6. The actuation assembly according to claim 3, wherein the annular pistons can be moved relative to one another in an axial direction with an interposition of a sealing device.

7. The actuation assembly according to claim 3, wherein the respective pressing connections and the common release connection are provided on a housing body in which the annular pistons are also accommodated so as to be movable back and forth.

8. The actuation assembly according to claim 7, wherein two annular pressing spaces and a common annular release space are formed in the housing body, wherein the two annular pressing spaces are hydraulically separated from one another by sealing devices and/or the annular pistons.

9. The actuation assembly according to claim 3, wherein the annular pistons are connected to disc packs via bearing devices and pressure pieces for force transmission.

10. A method for hydraulically actuating at least two sub-clutches/brakes with an actuation assembly according to claim 1, wherein the respective release paths of the sub-clutches/brakes are bridged via the common release connection before the respective pressing forces required to generate a desired torque transmission are generated independently of one another via the respective functional pressing surfaces of the sub-clutches/brakes.

11. An actuation assembly for hydraulically actuating first and second sub-clutches or brakes, comprising:
a hydraulic functional release surface;
a first pressing surface, larger than the hydraulic functional release surface, arranged to generate a pressing force to the first sub-clutch or brake to transmit torque;
a second pressing surface, larger than the hydraulic functional release surface, arranged to generate a pressing force to the second sub-clutch or brake to transmit torque; and
a common release connection for bridging respective release paths of the first and second sub-clutches or brakes before the first and second sub-clutches or brakes transmit respective torques.

12. The actuation assembly of claim 11, further comprising:
a first pressing connection for the first sub-clutch; and
a second pressing connection for the second sub-clutch, wherein the first and second pressing connections are subjected to different pressing forces.

13. The actuation assembly of claim 12, further comprising first and second annular pistons comprising respective annular surfaces hydraulically connected to the common release connection.

14. The actuation assembly of claim 13 wherein:
the first and second annular pistons comprise respective stepped sides; and
the respective annular surfaces are formed the respective stepped sides.

15. The actuation assembly of claim 13 wherein the respective annular surfaces are arranged radially nested.

16. The actuation assembly of claim 13 wherein the first and second annular pistons are:
movable relative to one another in an axial direction; and
sealed to one another by a sealing device.

17. The actuation assembly of claim 13 further comprising a housing body, wherein:
the first and second pressing connections and the common release connection are provided on the housing body; and
the first and second annular pistons are linearly movable in the housing body.

18. The actuation assembly of claim 17, further comprising:
a first annular pressing space formed in the housing body;
a second annular pressing space formed in the housing body; and
a common annular release space formed in the housing body, wherein the first annular pressing space, the second annular pressing space and the common annular pressing space are separated from one another by sealing devices, the first annular piston, or the second annular piston.

19. The actuation assembly of claim 13 wherein the first and second annular pistons are connected to respective disc packs via respective bearing devices and pressure pieces for force transmission.
